(19) United States
(12) Patent Application Publication
(10) Pub. No.: US 2010/0224663 A1
(43) Pub. Date: Sep. 9, 2010

(54) Carrier Assembly For Vehicle

(76) Inventor: Prince A. Butler, III, Clinton, MD (US)

Correspondence Address: L.C. Begin & Associates, PLLC, 510 Highland Avenue, PMB 403, Milford, MI, 48381, US

(21) Appl. No.: 12/717,669

(22) Filed: Mar. 4, 2010

Related U.S. Application Data
(60) Provisional application No. 61/157,772, filed on Mar. 5, 2009.

(51) Int. Cl. B60R 9/06

(52) U.S. Cl. 224/498; 224/519; 150/154

(57) ABSTRACT

One embodiment of a carrier assembly includes a platform member. The platform member includes a base, and a peripheral edge portion surrounding the base. The carrier assembly further includes a supporting arm attached to the base with the supporting arm adapted to be removably attached to a hitch of a vehicle. Further, the carrier assembly includes a plurality of panel members. Each of the panel members includes a pair of attaching legs adapted to be attached to the platform member for supporting the panel member on the platform member. Support of the plurality of panel members on the platform forms an enclosure. Further, at least one attaching leg of the pair of legs of a panel member is adapted to be detached from the platform member for facilitating displacement of the panel member to allow access to the formed enclosure.

### CROSS REFERENCE TO RELATED APPLICATION

This application claims the benefit of U.S. Provisional Application No. 61/157,772 filed on Mar. 5, 2009, the disclosure of which is incorporated by reference.

### FIELD OF THE DISCLOSURE

The present disclosure generally relates to vehicles, and, more particularly to a carrier assembly for vehicles.

### BACKGROUND OF THE DISCLOSURE

Typically, various types of vehicles are employed for transporting individuals and/or goods from one location to another location. Generally, the vehicles include a seating area intended to be occupied by the individuals and a storage area intended for the placement of goods. The area intended for the placement of goods is often present near a rear part of the vehicles. However, such area of the vehicle often proves to be insufficient for carrying a variety of goods. Moreover, the area of the vehicle for the placement of goods is also ill-equipped to carry bulkier goods such as grilling equipments and the like. Further, odorous and unhygienic goods are also avoided from being stored in such area of the vehicle as such goods may prove harmful for the individuals present in the vehicle.

To solve this problem, an additional wheeled-carrier for transporting goods may be connected to the vehicle. Specifically, the additional wheeled-carrier is attached to the rear part, and more specifically hitch, of the vehicle. However, the connection of the additional wheeled-carrier to the rear part of the vehicles is generally a time consuming and cumbersome one. Moreover, the additional wheeled-carrier may have tail lights and wirings associated with the tail lights. Such wirings are required to be connected to electrical connections of the vehicles. Such connection of the wirings and the electrical connections is also time consuming and difficult for the individuals, such as a driver. In addition, the additional wheeled-carrier also obstructs view of the driver while viewing a rear side of a road. Further the additional wheeled-carrier often hides parts of the vehicle, such as braking lights and license plate, thereby making it difficult for others to see the braking lights and license plate. Moreover, the additional wheeled-carrier often requires an additional license plate.

### SUMMARY OF THE DISCLOSURE

One embodiment of a carrier assembly for a vehicle may include a platform member. The platform member may include abuse, and a peripheral edge portion. The peripheral edge portion may surround the base. The carrier assembly may further include a supporting arm attached to the base of the platform member. An end portion of the supporting arm may be adapted to be removably attached to a hitch of the vehicle. Further, the carrier assembly may include a plurality of panel members. Each panel member of the plurality of panel members may have a pair of attaching legs. The pair of attaching legs of the panel member of the plurality of panel members may be adapted to be attached to the peripheral edge portion of the platform member for supporting the panel member of the plurality of panel members on the platform member. Supporting of the plurality of panel members on the platform member may form an enclosure adapted to contain one or more articles. Further, at least one attaching leg of the panel member of the plurality of panel members may be capable of being detached from the platform member for facilitating displacement of the panel member with respect to the platform member. The displacement of the panel member of the plurality of panel members with respect to the platform member allowing access to the formed enclosure.

### BRIEF DESCRIPTION OF THE DRAWINGS

The advantages and features of the present disclosure will become better understood with reference to the following detailed description and claims taken in conjunction with the accompanying drawing, in which:

FIG. 1 is a perspective view of a carrier assembly capable of being attached to a vehicle;

FIG. 2 is an exploded view of the carrier assembly of FIG. 1;

FIG. 3 is a perspective view of an embodiment of the carrier assembly of FIG. 1 having a swinging door configuration;

FIG. 4 is a perspective view of another embodiment of the carrier assembly of FIG. 1 having a removable door configuration;

FIG. 5 is a perspective view of the carrier assembly of FIG. 1 having a roof member carried by a top end portion thereof; and

FIG. 6 is a perspective view of the carrier assembly of FIG. 1 having a zippered waterproof cover secured thereto.

Like reference numerals refer to like parts throughout the description of several views of the drawings.

### DETAILED DESCRIPTION OF THE DISCLOSURE

The exemplary embodiments described herein detail for illustrative purposes are subject to many variations in structure and design. It should be emphasized, however, that the present disclosure is not limited to a particular carrier assembly as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms, “first,” “second,” “top,” “bottom,” and the like, herein do not denote any order, elevation or importance, but rather are used to distinguish one element with another. Further, the terms, “a” and “an” herein do not denote a limitation of quantity, but rather denote the presence of at least one of the referenced item.

The present disclosure provides a carrier assembly for use in collecting one or more articles from one location to another. Specifically, the carrier assembly may be attached to a vehicle for enabling transportation of one or more articles from one location to another in a safe, quick and convenient manner.

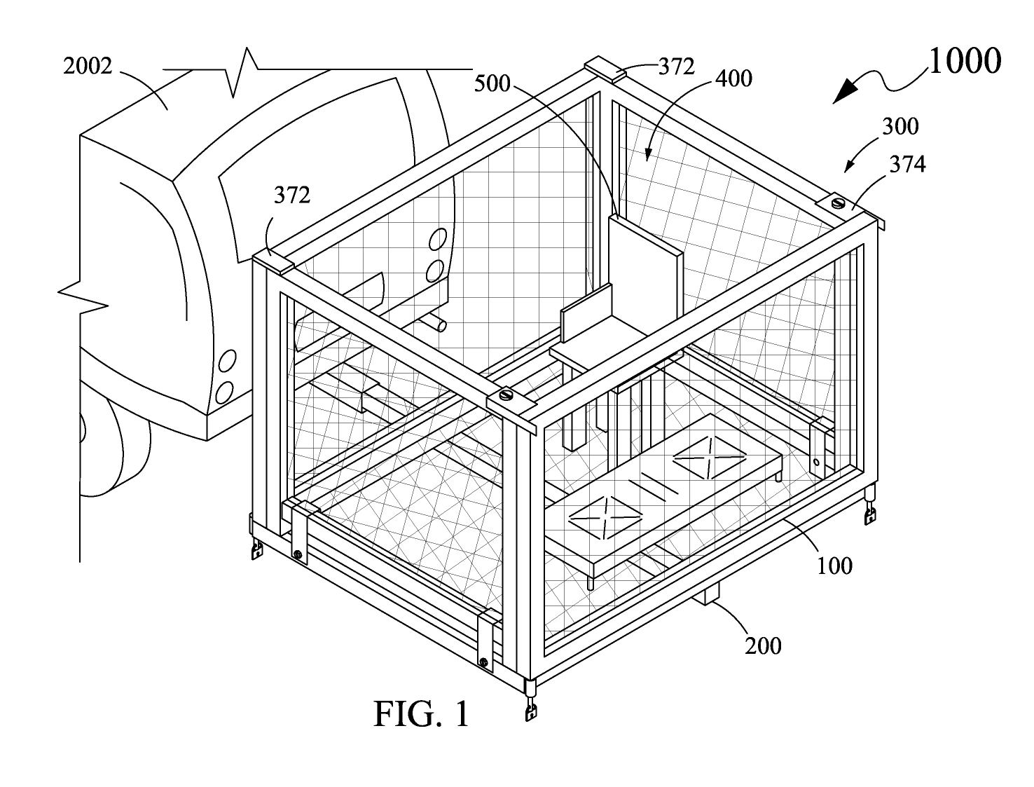

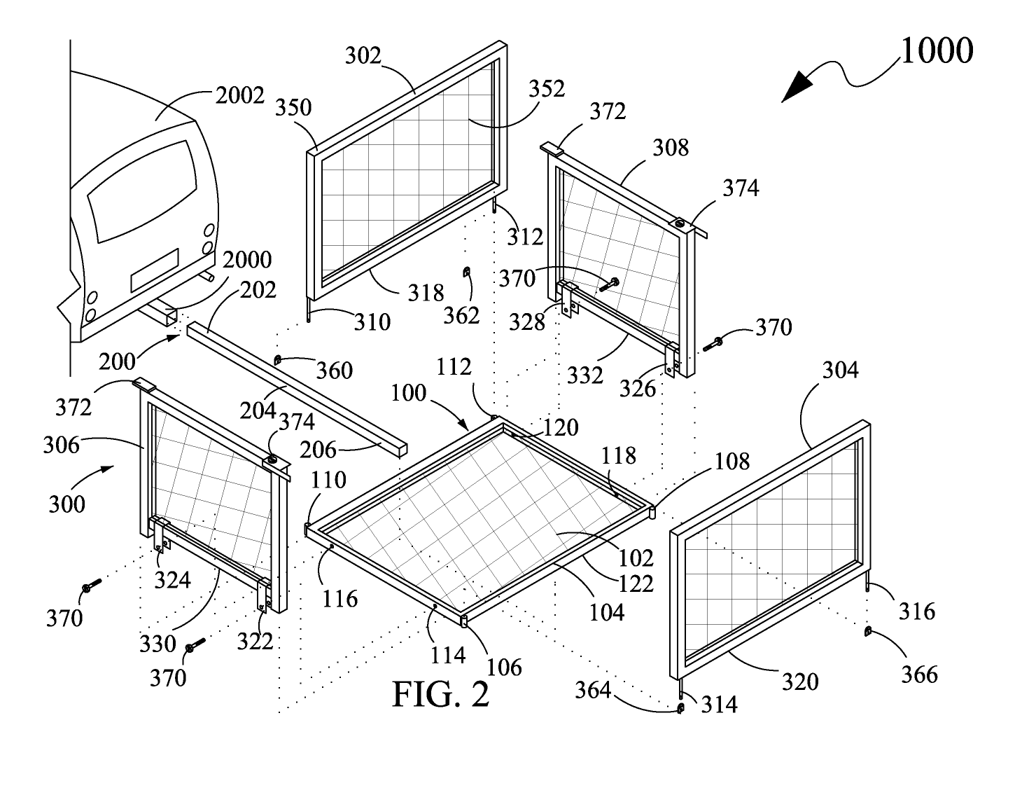

Referring to FIGS. 1 and 2, a carrier assembly 1000 may include a platform member 100. The platform member 100 may include a base 102 and a peripheral edge portion 104 surrounding the base 102. The base 102 may include a framework of metallic bars or grills. The peripheral edge portion 104 may include a plurality of attaching sockets, such as attaching sockets 106, 108, 110, 112. Each attaching sockets of the attaching sockets 106, 108, 110, 112 may be positioned at corners of the peripheral edge portion 104. The peripheral edge portion 104 may further include attaching hole, such as attaching holes 114, 116, 118, 120. As depicted in FIGS. 1 and 2, the platform member 100 may have a rectangular configuration. However, the platform member 100 may have any other configuration, such as a square configuration, and a circular configuration, without departing from the spirit of the disclosure. Further, the platform member 100 may be composed of a durable material, such as steel or aluminum. Alternatively, the platform member 100 may be composed of any other material, such as hardened plastic material, or a combination of similar materials.

The carrier assembly 1000 may further include a supporting arm 200. The supporting arm 200 may be attached to the base 102 of the platform member 102. More specifically, the supporting arm 200 may be welded to a lower surface 122 of the base 102. An end portion 202 of the supporting arm 200 may be adapted to be removably attached to a hitch 2000 of a vehicle, such as a vehicle 2002. More specifically, the supporting arm 200 may include a first end portion 202, an intermediate portion 204, and a second end portion 206. The first end portion 202 of the supporting arm 200 may be removably attached, and more specifically, removably received within the hitch 2000 of the vehicle 2002. Further, the intermediate portion 204 and the second end portion 208 are attached to the lower surface 122 of the base 102.

Even more specifically, the intermediate portion 204 and the second end portion 206 are welded at different points of the peripheral edge portion 104. The attaching of the supporting arm 200 to the base 102 of the platform member 100 provides support to the platform member 100. However, it should be clearly understood that the welding of the supporting arm 200 to the base 102 should not be construed as a limitation to the present disclosure. Accordingly, the supporting arm 200 may alternatively be bolted to the base 102.

Further, the supporting arm 200 may be composed of a durable material, such as steel, or aluminum. Alternatively, the supporting arm 200 may be composed of any other material, such as hardened plastic material, or a combination of similar materials.

Furthermore, the carrier assembly 1000 may also include a plurality of panel members 300. The plurality of panel members 300 may include a panel member 302, a panel member 304, a panel member 306 and a panel member 308. Each panel member of the plurality of panel members 300 may include a frame member and an arrangement of metallic bars supporting by the frame member. For example, the panel member 302 may include a frame member 350 and an arrangement of metallic bars 352 supported by the frame member 350.

Further, each panel member of the plurality of panel members 300 may be composed of a durable material, such as steel, or aluminum. Alternatively, the panel member 302 may be composed of any other material, hardened plastic material, or a combination of such materials.

Each panel member of the plurality of panel members 300 may also include a pair of attaching legs extending from a bottom portion thereof. For example, the panel member 302 and the panel member 304, include attaching legs 310, 312 and attaching legs 314, 316 respectively. The attaching legs 310, 312 and the attaching legs 314, 316 extend from a bottom portion 318 and a bottom portion 320 of the panel member 302 and the panel member 304 respectively. Further, each attaching leg of the attaching legs 310, 312 and the attaching legs 314, 316 includes a hole (not numbered).

Similarly, the panel member 306 and the panel member 308 include attaching legs 322, 324 and attaching legs 326, 328 respectively. The attaching legs 322, 324 and 326, 328 extend from a bottom portion 330 and a bottom portion 332 of the panel member 306 and the panel member 308 respectively. Each attaching leg of the attaching legs 322, 324 and 326, 328 includes a hole (not numbered).

The pair of attaching legs of the plurality of panel members 300 is adapted to be attached to the platform member 100 to attach the plurality of panel members 300 on the platform member 100. Specifically, the attaching legs 3|(i of the panel member 302 are adapted to be received in the attaching sockets 110, 112 respectively. Further, the attaching legs 314, 316 of the panel member 304 are adapted to be received in the attaching sockets 106, 108. Such receiving of the attaching legs 310, 312, 314 and 316 in the attaching sockets 106, 108, 110 and 112 may attach the panel member 302 and the panel member 304 on the platform member 100. Also, the attaching of the attaching legs in the attaching sockets may be secured using locks, such as locks 360, 362, 364, and 366. Specifically, pins of the locks 360, 362, 364, and 366 may be received in the holes of the attaching legs for locking 310, 312, 314 and 316 in the attaching sockets 106, 108, 110 and 112.

Further, the attaching legs 322, 324 of the panel member 306 may be aligned to the attaching holes 114, 116 and then fastened by means of locking nuts, such as locking nuts 370, to the platform member 100. Similarly, the attaching legs 326, 328 of the panel member 308 may be aligned to the attaching holes 118, 120 and then fastened by means of locking nuts, such as the locking nuts 370, to the platform member 100.

Additionally, the plurality of panel members 300 may include a set of aligning tabs 372 disposed on top corners of the plurality of panel members 300. The aligning tabs 372 may assist in aligning and locking the plurality of panel members 300 with respect to one another. Further, each of the panel member 306 and the panel member may include coupling tabs 374. The coupling tabs 374 may assist in removably joining the panel member 306 and the panel member 308 to the panel member 304.

The attaching of the plurality of panel members 300 on the platform member 100 forms an enclosure 400 adapted to contain one or more articles 500 therein. The one or more articles 500 may be grilling equipments, folding tables and chairs, coolers, tents, containers and other such articles. Preferably, the enclosure 400 may be adapted to carry a load of about 500 pounds to 600 pounds. Further, the enclosure 400 may have dimensions of about 32″ depth, 54″ width and 54″ height. The arrangement of metallic bars of each of the plurality of panel members 300, such as the arrangement of metallic bars 352 of the panel member 302, precludes the one or more articles 500 contained in the enclosure from falling out of the enclosure 400. Additionally, the arrangement of metallic bars 352 of the panel member 302 may be utilized for tying the one or more articles 500 contained in the enclosure by a string or cable to preclude movement of the one or more articles 500 while the vehicle 2002 is in motion.

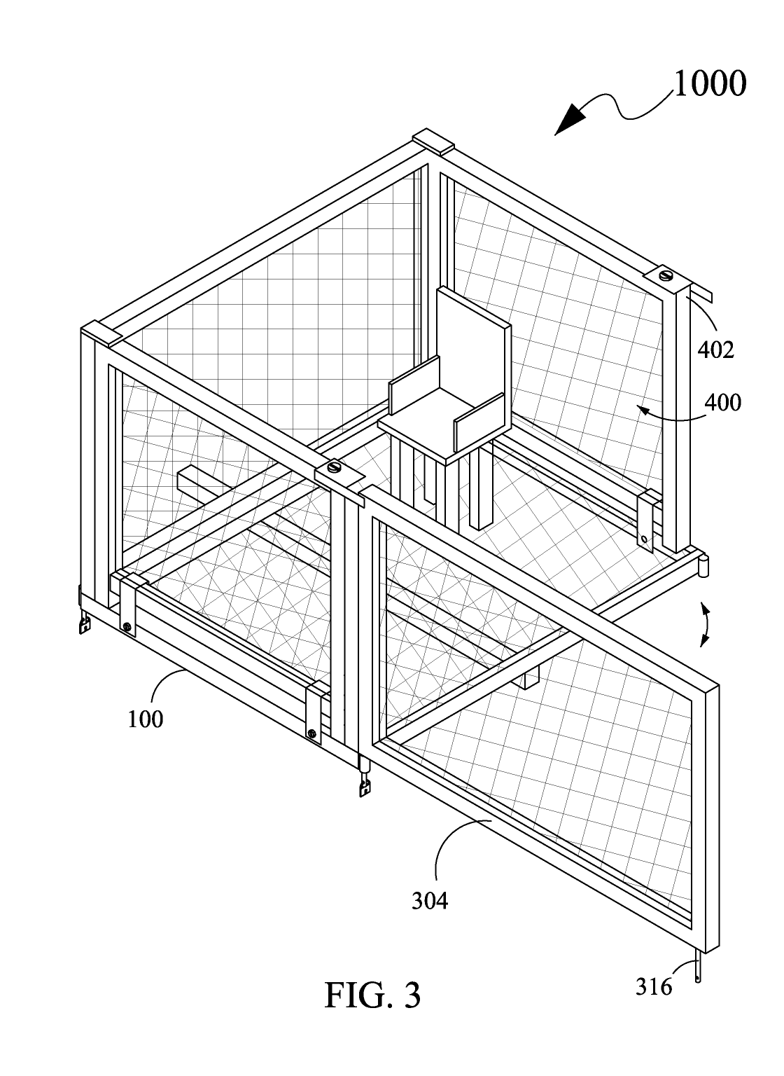

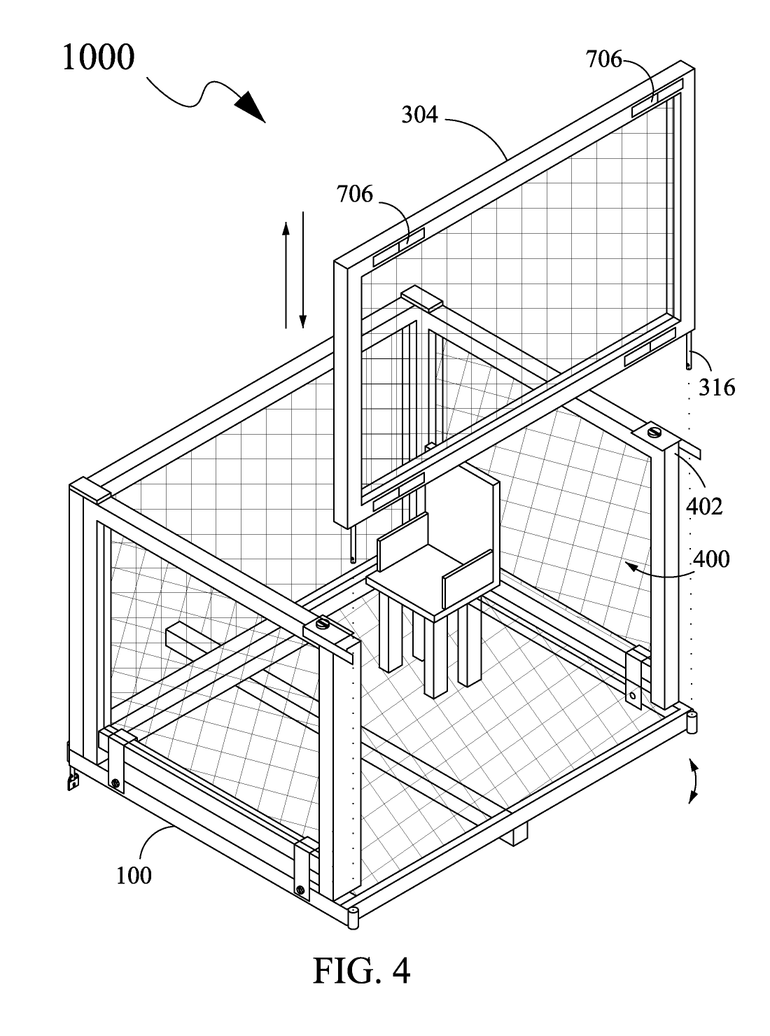

As best shown in FIGS. 3 and 4, the at least one attaching leg, is capable of being detached from the platform member 100. The respective attaching leg(s) may for example be spring biased to remain in the respective socket, and then simply depressed in an upward direction to remove from the respective socket. Other means of removably securing the attaching legs are contemplated, and will be appreciated by those in the art.

In an embodiment, one of the pair of attaching legs, such as the attaching leg 316 of the panel member 304, may be detached from the platform member 100 to configure the panel member 304 as a swinging door for allowing the access to the formed enclosure 400. Specifically, the panel member 304 may be adapted to swing to form an open configuration (shown in FIG. 3) from a closed configuration.

Alternatively, in another embodiment, the pair of attaching legs, such as the attaching legs 314, 316 of the panel member 304, may be detached from the platform member 100 to configure a removable door configuration (shown in FIG. 4). Such configuration may allow removal of the panel member 304 from the platform member 100, preferably by lifting the panel member 304 upwards. Accordingly, the removal of the panel member 304 from the platform member 100 allows the access to the formed enclosure 400.

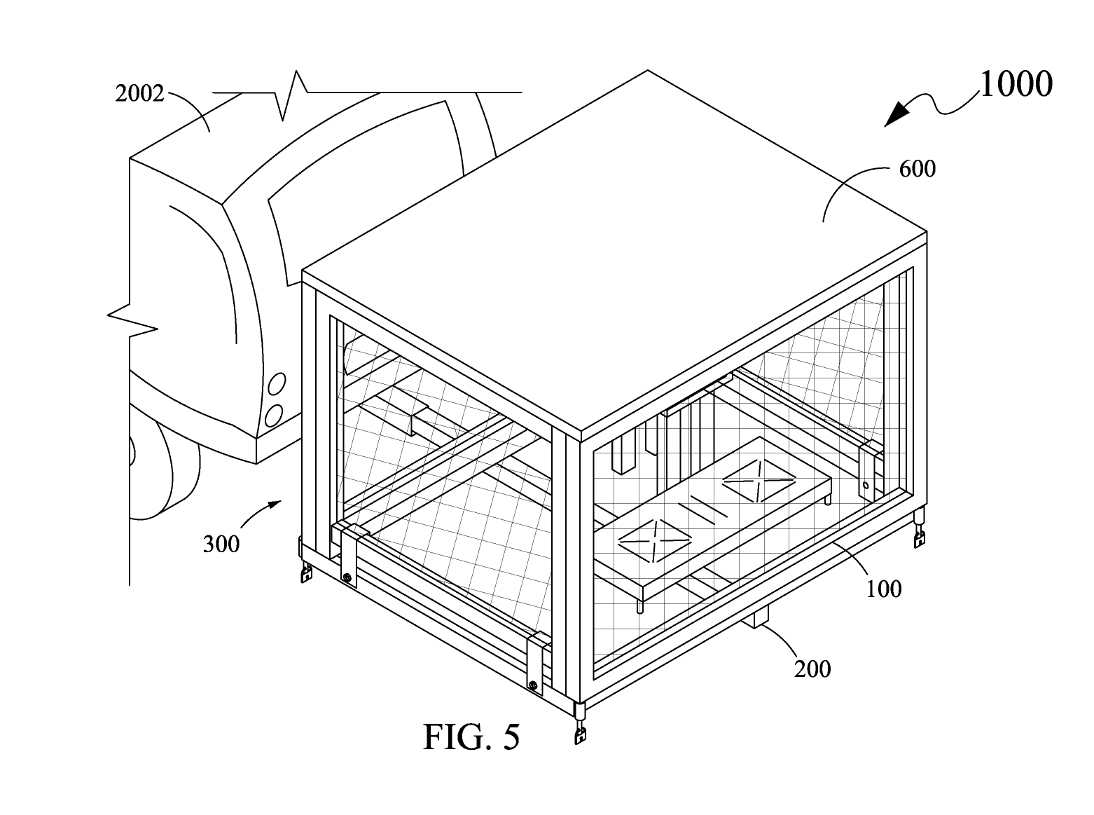

Additionally, the carrier assembly 1000 may include a roof member 600 (shown in FIG. 5). The roof member 600 may be carried by a top end portion 402 of the enclosure 400. The roof member 600 may be adapted to cover the one or more articles 500 contained by the enclosure 400. The roof member 600 may be composed of a durable material, such as steel. Alternatively, the roof member 600 may be composed of any other material, such as aluminum, hardened plastic material, or a combination of similar materials.

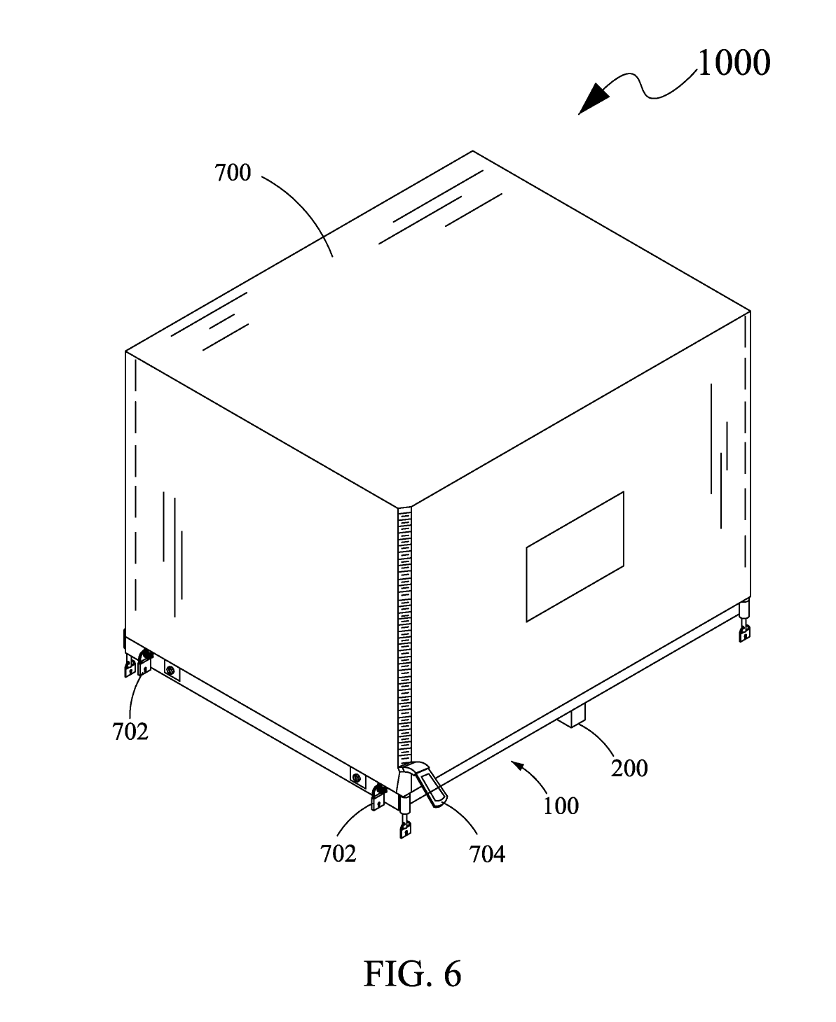

Further, the carrier assembly 1000 may include a zippered waterproof cover 700 shown in FIG. 6. Other containment or attachment means or methods, including tie downs and/or Velcro strips, are also contemplated. The zippered waterproof cover 700 may be adapted to cover the enclosure by covering each of the plurality of panel members 300. Alternatively, zippered waterproof cover 700 may be adapted to cover the enclosure by covering the plurality of panel members 300 along with the roof member 600. The zippered waterproof cover 700 may be adapted to preclude water, such as rain water, from entering the enclosure 400 and wetting one or more articles 500 contained therein. The zippered waterproof cover 700 may be locked to the enclosure by means of auxiliary locks 702 and a zipper assembly 704. The auxiliary locks 702 may be attached to a locking bracket carried by the zippered waterproof cover 700 and an auxiliary locking bracket carried by a panel member, such as the panel member 306.

Also, the carrier assembly 1000 may include electrical or non-electrical reflection lights or reflectors, such as reflection lights or reflectors 706 (shown in FIG. 4). The reflection lights or reflectors 706 may be carried by one or more of the plurality of panel members 300, such as the panel member 304. Further, the carrier assembly 1000 may include one or more logos, such as a sports team signage (not shown), carried by one or more of the plurality of panel members 300, such as the panel member 304. Alternatively, the one or more logos may be carried by the zippered waterproof cover 700.

Based on the foregoing description of the present disclosure, a carrier assembly, such as the carrier assembly 1000 is provided. Specifically, a platform member, such as the platform member 100 may be attached to a hitch of a vehicle. A plurality of panel members, such as the plurality of panel members 300, of the carrier assembly may be removably attached to the platform member for configuring an enclosure, such as the enclosure 400. One or more articles, such as the articles 500 may be stored in the enclosure. Further, a panel member, such as the panel member 304 of the plurality of panel members 300 may be displaced with respect to the platform member for allowing access to the enclosure.

During utilization of the carrier assembly 1000, the platform member 100 may be attached to a hitch of a vehicle. The attachment of the platform member 100 to the hitch of the vehicle is quick and convenient. The plurality of panel members 300 of the carrier assembly 1000 may be removably attached to the platform member 100 to form an enclosure. The formed enclosure of the carrier assembly 1000 is capable of receiving a variety of bulky, odorous, and/or unhygienic articles. Further, since each panel member of the plurality of panel members 300 is made up of a framework of metallic bars, view of the braking lights, license plate is not obstructed and accordingly any need of having an additional license plate is avoided. Additionally, the carrier assembly 1000 may preclude the need of having additional wheels for supporting the carrier assembly 1000.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A carrier assembly for a vehicle, the carrier assembly comprising:
a platform member having
a base, and
a peripheral edge portion surrounding the base;
a supporting arm attached to the base of the platform member, an end portion of the supporting arm adapted to be removably attached to a hitch of the vehicle; and,
a plurality of panel members, each panel member of the plurality of panel members having a pair of attaching legs adapted to be attached to the peripheral edge portion of the platform member for supporting the panel member of the plurality of panel members on the platform member,
wherein supporting of the plurality of panel members on the platform ember forms an enclosure adapted to contain one or more articles.

2. The carrier assembly of claim 1, wherein at least one attaching leg of a panel member of the plurality of panel members is capable of being detached from the platform member for facilitating displacement of the panel member with respect to the platform member.

3. The carrier assembly of claim 1, wherein one of the pair of attaching legs of the panel member is capable of being detached from the platform member, wherein the detaching of one of the pair of attaching legs of the panel member from the platform member configures the panel member as a swinging door for allowing access to the formed enclosure.

4. The carrier assembly of claim 1, wherein the pair of legs of the panel member is capable of being detached from the platform member, wherein the detaching of the pair of attaching legs of the panel member from the platform member removes the panel member from the platform member for allowing access to the formed enclosure.

5. The carrier assembly of claim 1, wherein the pair of attaching legs extend from a bottom portion of the panel member of the plurality of panel members.

6. The carrier assembly of claim 1 further comprising a roof member carried by a top end portion of the enclosure, the roof member adapted to cover the enclosure.

7. The carrier assembly of claim 1 further comprising a zippered waterproof cover disposed on the enclosure for precluding water from damaging the one or more articles contained by the enclosure.

8. The carrier assembly of claim 1, wherein the plurality of panel members is composed of one of a steel material, an aluminum material, a hardened plastic material, and a combination thereof.
